(19) United States
(12) Patent Application Publication
(10) Pub. No.: US 2004/0042634 A1
(43) Pub. Date: Mar. 4, 2004

(54) Referencing information in an image

(76) Inventor: Robert P. Cazier, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/231,650

(22) Filed: Aug. 30, 2002

(51) Int. Cl. G06K 9/00

(52) U.S. Cl. 382/100

(57) ABSTRACT

A method and apparatus for encrypting information into an image and/or for determining information encrypted into an image are disclosed.

### CROSS-REFERENCE TO RELATED APPLIACTIONS

This application is related to U.S. patent application Ser. No. ______ to be assigned, filed on the same date as the present application, and entitled “SYSTEM AND METHOD FOR DATA ENCRYPTION/DECRYPTION”, docket 10016762-1, which is entirely incorporated herein by reference.

### BACKGROUND

In digitally based image capturing devices an image or “photograph” of an object is stored in a digital data format in the memory within, or coupled to, the image capturing device. A nonlimiting example of a digital image capturing device is the digital camera that captures still images and/or video images. Captured images are stored in a memory that resides within or is coupled to the digital camera.

Watermarking and other information embedding techniques are known in the art for storing information in individual digital images. Such techniques allow information to be retrieved at a later time. Often, such information is used to verify the validity of the image and/or provide information of interest about the image.

Adding information into an image may be accomplished by altering the data of individual pixels. The term encryption, as used herein, refers to the process of altering pixel data to encrypt (add) information into the image, thereby generating an encrypted image. The term decryption, as used herein, refers to the process of decrypting (retrieving or reading) the information from the encrypted pixel data.

Many image encryption and decryption technologies are complex. Once implemented, some encryption techniques require a substantial amount of computational capacity and time from the processing device that encrypts and/or decrypts the image. Furthermore, when a public/private key system is employed, separate data files must be separately managed in a secure manner to prevent an unauthorized individual from having access to the keys. Keys allow only authorized persons to retrieve the information encrypted into the image. Other encryption systems may also employ separate files that must be securely communicated to the intended recipient of the decrypted image.

Encryption techniques, such as watermarking, alter information in selected pixels such that the altered pixels contain encryption information. The encryption information is detected electronically during decryption to retrieve the encrypted information. Such information may be used for verifying that the image has not been tampered with, forged or otherwise altered. However, the amount of information in an image that can be stored by altering a pixel is limited.

Also, if the pixel data is altered too greatly, the altered pixels may be detectable by a person viewing the image. Altering pixel data to a point that is discernable to a person viewing the image is particularly undesirable when important portions of the image are encrypted. Thus, the degree of allowable pixel alteration is limited to being below the visibility threshold of the person viewing the image if the image is to remain visually pleasing to the viewer after encryption.

Furthermore, once a pixel is altered, such as when a watermark is added, that pixel is communicated to the intended recipient in its altered form. Accordingly, if the intended recipient desires to further process the image, such as by magnification, the watermark may become visible or otherwise hinder further processing of the image. In some encryption systems, restoring the altered pixel to its original, unaltered state is impossible or very difficult to accomplish.

### SUMMARY

A system and method for encrypting information into a digital image is disclosed. Briefly described, in architecture, one embodiment is a method comprising the steps of receiving information corresponding to a captured image from a photosensor; generating a first image from the received information, the first image comprised of at least a plurality of first pixels corresponding to the captured image; generating a second image from the received information, the second image having a different resolution than the first image and comprised of at least a plurality of second pixels corresponding to the captured image; selecting a plurality of encryption pixels from the plurality of first pixels, such that each one of the plurality of selected encryption pixels corresponds uniquely to one of the plurality of second pixels of the second image; and altering data of each one of the selected plurality of encryption pixels such that information of interest is encrypted into the selected plurality of encryption pixels, and such that corresponding ones of the plurality of second pixels remains unaltered so that the information of interest is determinable by comparing the encrypted pixels with the unaltered second pixels.

Another embodiment is a method for determining information encrypted into an image file, the method comprising the steps of accessing at least a first image corresponding to a captured image comprised of at least a plurality of encryption pixels, and a second image corresponding to the captured image comprised of at least a plurality of second pixels, the second image having a different resolution than the first image, and each one of the plurality of second pixels uniquely corresponding to one of the plurality of encryption pixels; retrieving the plurality of encryption pixels; retrieving the plurality of corresponding second pixels; determining a difference between each one of the retrieved encryption pixels and the corresponding second pixel; and determining information corresponding to the determined difference.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating one embodiment of a thumbnail information encryption system implemented in a digital image capture device.

FIG. 2A is a block diagram illustrating an embodiment of a thumbnail information encryption system implemented in digital camera, and another embodiment of the thumbnail information encryption system implemented in a personal computer.

FIG. 2B is a block diagram illustrating a pixel location table 258 residing in memory 216 of digital camera 102.

FIG. 3A is a block diagram of selected components of an embodiment of a digital camera.

FIG. 3B is a block diagram illustrating a pixel location table 258 residing in memory element 302 of personal computer 202.

FIG. 4 is a flowchart of a process for encrypting information into a plurality of predefined pixel pairs residing in a high resolution image and in a thumbnail image.

FIG. 5 is a flowchart of a process for retrieving information from a plurality of pixel pairs residing in a high resolution image and in a thumbnail image.

FIG. 6 is a flowchart of a process for encrypting a plurality of sequential pixel pairs residing in a high resolution image and in a thumbnail image with information.

FIG. 7 is a flowchart of a process for defining a plurality of pixel pairs residing in a high resolution image and in a thumbnail image based upon a predefined portion of an image file header.

FIG. 8 is a block diagram of selected components of an embodiment of a digital camera having camera decryption logic.

### DETAILED DESCRIPTION

A system and method for encrypting a digital image and/or a thumbnail image with information of interest is described in detail below. For convenience, a “digital image” is defined herein to include any of the various forms of digital information corresponding to an image that is captured by an image capture device.

As described herein, information of interest, or for brevity, information, may comprise any type of information that is suitable for encryption into an image. Non-limiting examples of information include a header, a file name, image capture device settings, a date, a time, light conditions, other images, meta data or any other information of interest. As described in detail below, such information, when represented as a numerical value, is encrypted into selected encryption pixels. For example, but not limited to, a message consisting of a character string may be converted into a numerical string using a predefined character set. As another non-limiting example, a second image may be represented as a numerical string and encrypted into selected encryption pixels. Accordingly, any information that can be represented as a numerical string, described below in greater detail, may be stored in an image in accordance with this system.

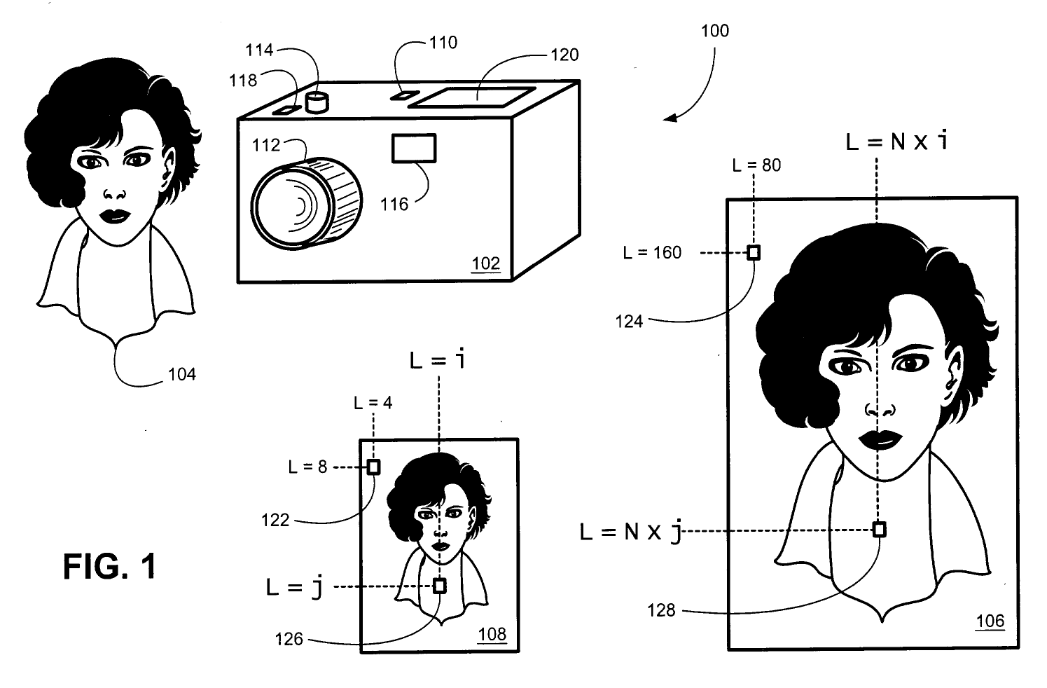

FIG. 1 is a block diagram illustrating one embodiment of a thumbnail information encryption system 100 implemented in a digital image capture device. For convenience, one embodiment of the encryption system is implemented in a digital camera 102. Other embodiments of the thumbnail information encryption system 100 can be implemented in any suitable image capture device, such as, but not limited to, a digital camera, a video camera, a facsimile (FAX) machine, a copy machine, a document scanner or the like.

Here, an image of a lady 104 is illustrated as being captured by digital camera 102. As described in greater detail below, when light is detected by a plurality of photosensor pixel elements, light information is generated. The light information is received and processed to generate at least two captured images of the lady 104. One image is a high resolution image 106. Another image is a lower resolution image, referred to herein for convenience as a thumbnail image 108. Thumbnail image 108 may be any suitable image having a relatively lower resolution than the high resolution image 106. Preferably, the generated high resolution image 106 and the generated thumbnail image 108, along with other information such as a file name and header information, is combined into a single file, referred to herein as an image file.

Digital camera 102 may include a control button 110, a lens unit 112, an image capture actuation button 114, a viewing lens 116, a power switch 118 and display 120. Display 120 is used for previewing images prior to capturing or for viewing one or more thumbnail images 108 after image capture. For convenience of illustration, display 120 is illustrated on the top of digital camera 102.

The high resolution image 106 is comprised of data from very many pixels. For example, one embodiment of digital camera 102 includes a photosensor 304 (FIG. 3A) having approximately three million pixel elements. Accordingly, the digital data in high resolution image 106 may have information corresponding to three million pixel elements. However, an image file having a high resolution image 106 with data corresponding to three million pixel elements is generally too large to be conveniently stored and/or communicated to other devices. Accordingly, the light information from the pixel elements is processed into data that corresponds to a relatively small, predefined area of the photosensor (or a predefined grouping of the pixel elements), hereinafter referred to for convenience as a pixel. For example, light information from three pixel elements (one sensitive to red light, an adjacent pixel element sensitive to green light and an adjacent pixel element sensitive to blue light) is processed into a single pixel having red, green and blue light information. Furthermore, the pixel includes location information that defines the location of that pixel on the image.

In some embodiments of digital camera 102, greater numbers of pixel elements may be specified to define a pixel. For example, rather than the three pixel elements described above (one red, one green and one blue pixel elements), nine pixel elements may be specified to form a pixel (three red, three green and three blue pixel elements). Accordingly, required memory capacity for storing the high resolution image 106 when nine pixel elements are employed is reduced by approximately a third. Pixel elements can be grouped in any suitable manner, so long as the final pixel is sufficiently small to provide acceptable image resolution when the data is processed to display the captured image. One embodiment includes a feature that enables a user of the image capture device to define, by proxy, the number of pixel elements combined to form a single pixel. Here, the user specifies the desired memory size of the image file (which includes at least header information, high resolution image 106 and thumbnail image 108).

When light information received from the pixel elements is processed into pixels for high resolution image 106, selected pixels are used to generate thumbnail image 108. Thumbnail image 108, accordingly, has a relatively small number of pixels (compared to high resolution image 106). When the thumbnail image 108 is displayed on display 120, the relative size of display 120 is such that the thumbnail image 108 is viewed with sufficient resolution so that thumbnail image 108 is visually pleasing to the viewer. Furthermore, because the size of the data file for thumbnail image 108 is relatively small, the data for the thumbnail image can be quickly retrieved, processed and displayed on display 120.

If high resolution image 106 is displayed on the display 120, an undesirable time delay would be required to process and to display high resolution image 106. Furthermore, a significant amount of processing capacity would be required to generate an image suitable for display on display 120. Also, in portable embodiments of image capture devices, a corresponding amount of limited power supply (such as a battery) would be required to generate a suitable image from the data of high resolution image 106. Thus, when a captured image is displayed on display 120, thumbnail image 108 is retrieved from memory 302 (FIG. 3A) to save time and/or to conserve limited power resources.

In one embodiment, thumbnail image 108 is generated from high resolution image 106 by selecting pixels from high resolution image 106. Accordingly, each pixel in thumbnail image 108 has a corresponding pixel in high resolution image 106. The data for the pixel in thumbnail image 108 is the same as the data for the corresponding pixel in high resolution image 106. Furthermore, the pixel in thumbnail image 108 is spatially related to the corresponding pixel in high resolution image 106, as described in greater detail below.

In another embodiment, pixels in thumbnail image 108 and the corresponding pixel in high resolution image 106 are generated concurrently. Accordingly, as photosensor 304 is read, light information from selected pixels are used to concurrently generate a thumbnail image 108 and a high resolution image 106. For example, one embodiment uses light information from every tenth pixel to generate thumbnail image 108. All pixels are used to generate high resolution image 106.

As described above, after thumbnail image 108 is generated, the data of the individual pixels in thumbnail image 108 is the same as the data of the corresponding pixels in high resolution image 106. Furthermore, pixels in thumbnail image 108 are spatially related to their corresponding pixels in high resolution image 106, as described in greater detail below.

Each pixel in thumbnail image 108 is spatially related to a corresponding pixel in high resolution image 106. Thus, the relative position of a thumbnail pixel in thumbnail image 108 has the same relative position as its corresponding pixel has in high resolution image 106. For example, the location of thumbnail pixel 122 is illustrated as having a location of 4,8 (where 4 is the horizontal direction along the x-axis, 8 is the downward vertical direction on the y-axis, the x-axis and y-axis origin at the upper left-hand corner of the image), and is denoted as “L=4” and “L=8” in FIG. 1.

Pixel 122 spatially corresponds to pixel 124 of the high resolution image 106. That is, pixels 122 and 124 have the same relative position in their respective image. For example, but not limited to, thumbnail image 108 is arbitrarily illustrated as being twenty (20) times smaller, in length and in width, than high resolution image 106 in the simplified illustrative example of FIG. 1. Thus, the difference in the locations of pixels 122 and 124 differ by a factor of 20. Accordingly, the location of pixel 122, defined as 4,8 on thumbnail image 108, corresponds to pixel 124 having a location defined as 80,160 (where 80 is the horizontal direction along the x-axis, 160 is the downward vertical direction on the y-axis, the x-axis and y-axis origin at the upper left-hand corner of the image) on high resolution image 106. That is, the location of pixel 122 is known relative to the location of pixel 124. The corresponding low resolution and high resolution pixels 122 and 124 are hereinafter defined as a “pixel pair” for convenience.

Each of the pixels of thumbnail image 108 have a corresponding pixel in the high resolution image 106. That is, light information from selected pixels used to generate a thumbnail image 108 has a corresponding pixel in the high resolution image 106 that comprises the same data. Generally, any pixel 126, defined by location i, j on thumbnail image 108, has a corresponding pixel 128 defined by a location (N×i) and (N×j) on high resolution image 106. The term “N” above corresponds to the relative displacements between a pixel on thumbnail image 108 and high resolution image 106. In the simplified illustrative example described above, the value of N is 20 because the x-axis value of pixel 122 is 4 and the x-axis value of pixel 124 is 80 (4×20=80). Also, the y-axis value of pixel 122 is 8 and the y-axis value of pixel 124 is 160 (8×20=160). Accordingly, pixels of thumbnail image 108 have a corresponding pixel in the high resolution image 106. That is, for each of the pixels comprising thumbnail image 108, a pixel pair is defined using the corresponding pixel in high resolution image 106.

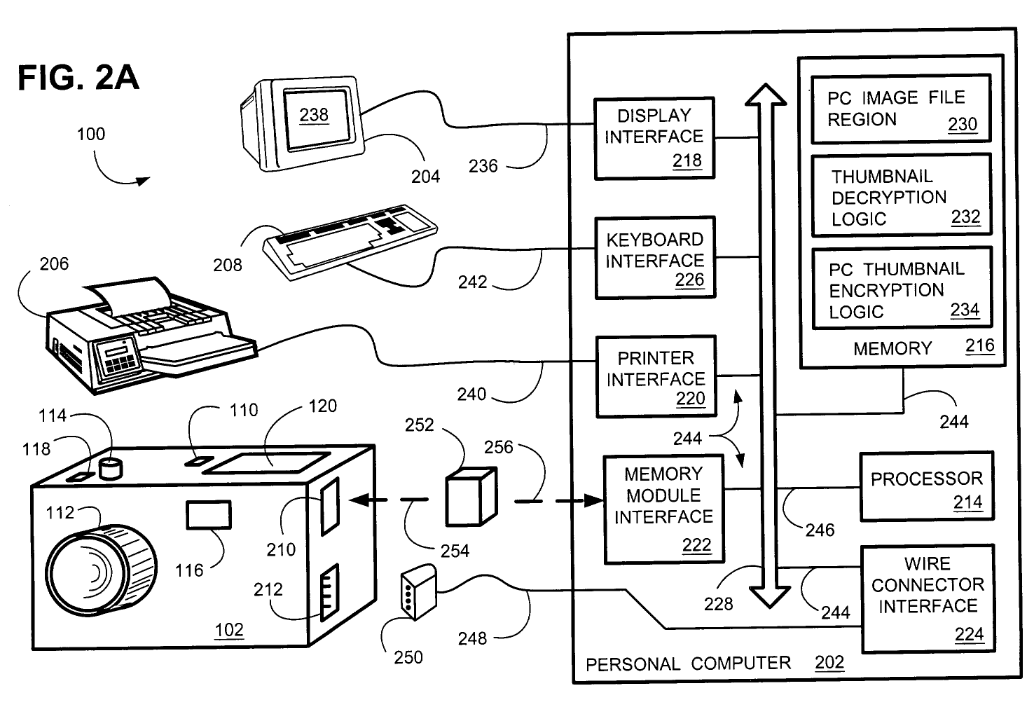

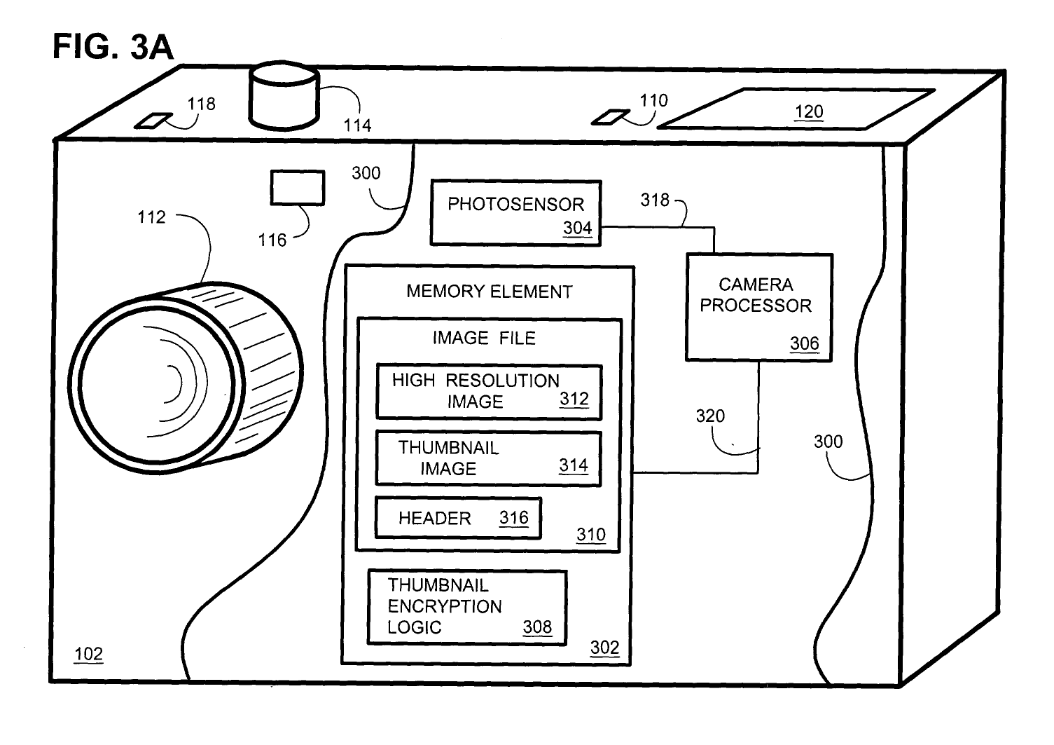

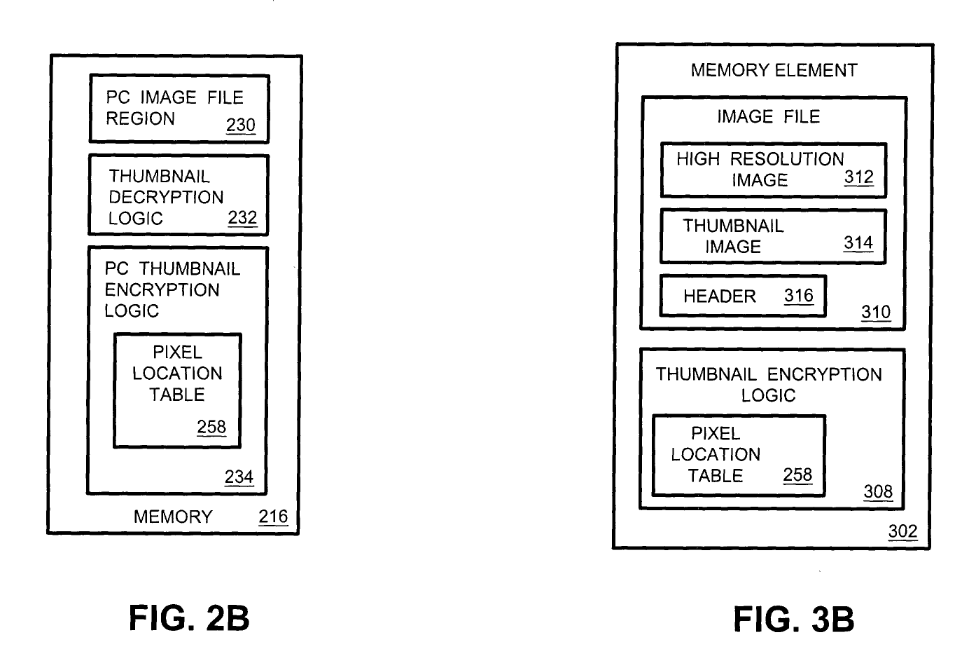

The location system described above is a very simplistic illustrative Cartesian coordinate system. The location of pixels in thumbnail image 108, and its corresponding pixel location on high resolution image 106, can be defined using any suitable coordinate system or location system. Cartesian coordinates or polar coordinates are non-limiting examples of coordinate systems that are used by embodiments of digital camera 102 (and personal computer 202, described below in FIG. 2). Also, the relative displacement N described above was an arbitrary value selected to demonstrate the spatial relationship between a pixel in thumbnail image 108 and its corresponding pixel in high resolution image 106. Any suitable relative displacement factor can be employed by various embodiments.

Furthermore, pixel 122 is illustrated as a relatively large square for convenience. A pixel is actually much smaller than the square used to illustrate pixel 122 (and other pixels described herein), and that the use of the square illustrating a single pixel is merely demonstrative.

One embodiment of the thumbnail information encryption system 100 is predicated on pixel 122 having data that is the same as the data for pixel 124. Since pixel 122 and pixel 124 are comprised of the same data, and since high resolution image 106 and thumbnail image 108 are communicated together in a single image file 310 (FIG. 3A), one of the pixels of the pixel pair is selected to be the carrier of encryption information. For convenience, the pixel of a pixel pair selected to carry information is referred to herein as the encrypted pixel. Accordingly, when the image is encrypted, data for one of the pixels of a pixel pair is altered with information data referred to herein as encryption information. The other pixel of the pixel pair is not altered, and is used as a reference pixel or an unaltered pixel. Thus, when the image is decrypted, the pixel data for the two pixels of a pixel pair are compared, and the difference in the pixel data corresponds to the encrypted information.

Returning to the simplified illustrative example of FIG. 1, pixel 124 is arbitrarily selected as the encrypted pixel. Thus, pixel data for pixel 124 is altered by adding encryption information. Pixel 122 is the reference pixel or unaltered pixel.

For example, if pixel 124 contained red, green, blue data of 1,3,1 (where the red=1, green=3 and blue=1), the green value could be encrypted to carry the encryption information of 1 by altering the pixel data to 1,4,1. Thus, the green data is increased from a value of 3 to a value of 4 to carry the encryption information of 1.

For convenience, the above-described simplified illustrative example presents the pixel data for pixel 124 as having three base-ten numbers, each number representing a blue value, a green value and a red value. In one embodiment, the pixel data is represented as three 8-bit words, where three bits would represent each color. Thus, the red value of 1, base ten, described above would be represented as 001 with an 8-bit word. Other embodiments employ other data formats. For example, but not limited to, the pixel data may be part of a black-and-white image, where the pixel data represents grayscale data having a predefined number of bits (for example, but not limited to, two to eight bits), depending upon the embodiment. As another non-limiting example, another embodiment employs pixel data having twenty-four bits of information. Embodiments are equally applicable to any data format used to represent pixels, so long as there are two images available, a lower resolution image and a higher resolution image, such that encryption pixels from a plurality of pixel pairs are encrypted with information as described herein.

As described in greater detail below, a plurality of predefined pixels are selected in a predefined order for carrying encryption information. Thus, the predefined pixels can be encrypted to carry information. The manner in which pixels are selected for encryption, and the later decryption of the selected pixels, described in greater detail below.

For convenience, the term encryption used herein refers to the alteration of pixel data to represent at least a portion of the information. Similarly, the term decryption used herein refers to the inspection of the altered pixel data to determine the above-described portion of the information. Thus, one of the pixels in the thumbnail image 108 or the high resolution image 106 is selected for encryption, identified herein as the encryption pixel. The other pixel (not having encrypted information) is defined herein as the reference pixel.

In the above-described, simplified illustrative example wherein data for pixel 124 was altered from 1,3,1 to 1,4,1, the small change in the data of the encrypted pixel is not likely to be visibly discernable to an individual viewing the image. Such encryption encrypts information in the selected encryption pixels of the pixel pairs having a value such that any distortion caused by an altered pixel is not visibly discernible to an individual viewing the image. Accordingly, the individual viewing an image having information encrypted into encryption pixels, without electronic analysis of the image, would not be aware that the image has been encrypted.

Alternatively, the encrypted information could have a value such that the altered pixel is visibly distorted. As another simplified illustrative example, data for pixel 124 could have been changed from 1,3,1 to 1,8,1 to encrypt a value of 5 into the green data. If many encrypted pixels were thus changed, the encrypted pixels could discernibly distort the encrypted image. However, since pixel 122 (residing in the thumbnail image 108) has not been altered, and since the value of pixel 122 is 1,3,1 (equal to the original value of pixel 124), the encrypted pixel 124 can be easily restored and/or reconstructed. That is, encrypted pixel 124 can be easily restored and/or reconstructed to a pre-encryption value of 1,3,1 since the reference pixel 122 (or unaltered pixel 122) specifies the pre-encryption value of pixel 124.

In the simplified illustrative examples described above, the green data was arbitrarily selected for altering. Any part of, or all of, the pixel data could be selected for encryption. The manner of encrypting information into a selected pixel is limitless. More significantly, because one of the pixels of a pixel pair has not been altered, the type of information embedded in an encrypted pixel is not limiting because the encrypted pixel can be restored and/or reconstructed from the reference pixel.

In an embodiment that encrypts pixels to an extent that the encrypted pixel is visibly distorted, a person not possessing an embodiment of a decryption system embodiment will be limited to viewing visibly distorted images since a plurality of encrypted pixels carrying information cannot be restored and/or reconstructed. However, a person possessing a valid decryption system embodiment is able to view undistorted images since encrypted pixels may be restored and/or reconstructed prior to displaying the image.

In another embodiment, the images are configured to automatically reconstruct prior to display, such that a viewer does not have to view a distorted image having a plurality of encrypted pixels. In this embodiment, an uninformed individual viewing the image would not be aware of the presence of encrypted information residing in the encrypted pixel. Accordingly, each image (having a thumbnail image 108 and a high resolution image 106) includes logic to decrypt the information and to reconstruct the encrypted pixels before the image is displayed. In one embodiment, the decryption code is included in the image file such that when the image file is opened, the encrypted pixels are automatically restored and/or reconstructed.

The above-described embodiment of a thumbnail information encryption system 100 is described using pixel pairs. Each pixel pair is comprised of a pixel from a thumbnail image and a high resolution image. Each pixel in a pixel pair has the same data and is spatially related. In another embodiment, the thumbnail image pixel and the high resolution image pixel have different data values, but the relationship between the pixel data of each pixel pair is known. Accordingly, when the encrypted pixel having encryption information is compared with the reference pixel, the data relationship is used to determine the data difference between the two pixels, and thereby allowing determination of the encryption information.

The above-described embodiment of a thumbnail information encryption system 100 is described as having one of the pixels of a pixel pair selected to receive the information. Data for the selected pixel is altered by embedding encryption information. One embodiment alters pixel data from a thumbnail image. Another embodiment alters pixel data from a high resolution image. Yet another embodiment is configured to select the encryption pixel in a predetermined manner, or even a random manner, so that parts of the encryption information is embedded in both the thumbnail image and the high resolution image.

Summarizing one embodiment, a pixel in thumbnail image 108 and a corresponding pixel in high resolution image 108, are pixel pairs. Initially, data for each pixel in a pixel pair is equal (or related by a known relationship). Furthermore, the pixels are spatially related to each other. One of the pixels of a pixel pair is selected for encryption (the encrypted pixel). Data for encrypted pixel is altered, as described herein, so that the information is embedded into the selected encrypted pixel. Data for the other pixel of the pixel pair (the reference pixel or the unaltered pixel) is not altered. By selecting a plurality of pixel pairs, any desired amount and type of information is embedded into an image by altering the selected encryption pixels. The encrypted information is determined by comparing the encryption pixel with the reference pixel of each pixel pair. In one embodiment, the encryption pixel is restored and/or reconstructed using the data of the reference pixel.

FIG. 2A is a block diagram illustrating an embodiment of a thumbnail information encryption system 100 implemented in digital camera 102. Another embodiment of the thumbnail information encryption system 100 is implemented in personal computer 202. Personal computer 202 may further include, or be coupled to, a display 204, a printing device 206, a user interface device 208 (keyboard) and other peripherial devices (not shown). Digital camera 102 further includes at least a memory unit interface 210 and a plug-in interface 212.

Personal computer 202 is configured to communicate with digital camera 102 such that digital images captured by digital camera 102 may be retrieved, encrypted and/or decrypted. Personal computer 202 includes at least a processor 214 and a memory 216. Personal computer 202 may further include a display interface 218, a printer interface 220, a memory module interface 222, a wire connector interface 224, a keyboard interface 226 and a communication bus 228 (in addition to many other components not illustrated in FIG. 2 for convenience).

Memory 216 further includes a personal computer (PC) image file region 230 (where at least one image file having at least a high resolution image and a thumbnail image reside), and thumbnail decryption logic 232 resides. The PC image file region 230 and thumbnail decryption logic 232 are described in greater detail below. An alternative embodiment of personal computer includes PC thumbnail encryption logic 234. Memory 216 may also contain other data, logic and/or information used in the operation of personal computer 202, however such data, logic and/or information are described herein only to the extent necessary to describe thumbnail information encryption.

Personal computer 202 is illustrated as being coupled to a display 204, via connection 236, so that captured images of a high resolution image and/or a thumbnail image encrypted as described herein can be viewed on display screen 238 residing in display 204. Personal computer 202 is further illustrated as being coupled to printer 206, via connection 240, so that a high resolution image and/or a thumbnail image is printed. Also, personal computer 202 is illustrated as being coupled to keyboard 208, via connection 242, so that an authorized individual can input relevant information regarding the encryption information and control execution of thumbnail decryption logic 232 and/or PC thumbnail encryption logic 234.

Memory 216, display interface 218, printer interface 220, memory module interface 222, wire connector interface 224 and keyboard interface 226 are coupled to communication bus 228 via connection 244. Communication bus 228 is coupled to processor 214 via connection 246, thereby providing connectivity to the above-described components. In alternative embodiments of personal computer 202, the above-described components are connectivley coupled to processor 214 in a different manner than illustrated in FIG. 2A. For example, one or more of the above-described components may be directly coupled to processor 214 or may be coupled to processor 214 via intermediary components (not shown).

For convenience, the user interface device 208 is hereinafter referred to as keyboard 208. Other suitable user interfaces are employed in alternative embodiments such that an authorized individual can input relevant information regarding the encryption information and control execution of thumbnail decryption logic 232 and/or PC thumbnail encryption logic 234.

In one embodiment of digital camera 102, digital camera 102 transfers captured image files to personal computer 202 via a hard wire connection 248. Connection 248 is coupled to a plug-in attachment 250. Plug-in attachment 250 is configured to connect to plug-in interface 212. The individual simply connects plug-in attachment 250 to plug-in interface 212 thereby establishing connectivity between digital camera 102 and personal computer 202. The authorized individual controlling execution of the thumbnail decryption logic 232, PC thumbnail encryption logic 234, or other logic configured to communicate image files, then instructs personal computer 202 and/or digital camera 102 to transfer image files from digital camera 102 into the PC image file region 230. As described above, the transferred image files include at least a high resolution image 106 and a corresponding thumbnail image 108 (FIG. 1).

In another embodiment, image files are stored in memory module unit 252. When capturing images with digital camera 102, memory module unit 252 is coupled to digital camera 102 through memory unit interface 210, as illustrated by dashed line path 254. Image files are transferred to personal computer 202 by removing memory module unit 252 from digital camera 102 and coupling memory module unit 252 to memory module interface 222. Typically, a convenient coupling port or interface (not shown) is provided on the surface of personal computer 202 such that memory module unit 252 is directly coupled to personal computer 202, as illustrated by dashed line path 256. Once memory module unit 252 is coupled to memory module interface 222, image files are transferred into the PC image file region 230.

FIG. 3A is a block diagram of selected components of an embodiment of digital camera 102. FIG. 3A includes selected external and internal components of the digital camera 102, demarked by cut-away lines 300. The internal components include at least memory 302, photosensor 304 and camera processor 306. In one embodiment, memory 302 further includes thumbnail encryption logic 308 and image file 310. Image file 310 is configured to store an image file having at least a high resolution image 312, a thumbnail image 314 and a header 316 that corresponds to a captured image.

Operation of digital camera 102 is initiated by actuation of power switch 118 or an equivalent device having the same functionality. Display 120 may display a view of an image currently visible through lens unit 112 and detected by photosensor 304, referred to herein as a preview image. When digital camera 102 is displaying a preview image, digital camera 102 is referred to herein as operating in a preview mode.

Alternatively, an image of a previously captured image may be viewed on display 120. When digital camera 102 is displaying a previously captured image, digital camera 102 is referred to herein as operating in a review mode. In one embodiment, as described above, the digital camera 102 displays thumbnail image 108 (FIG. 1) on display 120. Furthermore, a menu screen may be displayed on display 120. In one embodiment, other buttons, switches or control interface devices (not shown) are additionally configured to operate display 120 such that menu items may be selected.

Prior to capturing an image of an object, wherein the image is encrypted with information, the operator of digital camera 102 may visually preview the image of the object on display 120. Or, the object may be viewed directly through the viewing lens 116. Photosensor 304 is disposed in a suitable location behind lens unit 112 such that an image of the object is focused onto photosensor 304 for capturing. When the operator has focused the image of the object and is satisfied with the focused image, the operator actuates image capture actuation button 114 (also referred to as a shutter button or a shutter release button) to cause digital camera 102 to capture the image of the object, thus “photographing” the object. Photosensor 304 detects the image of the object through lens unit 112 and communicates digital image data corresponding to the detected image to the camera processor 306, via connection 318.

In one embodiment, the digital image data corresponding to the captured image is processed by camera processor 306 to generate an image file having at least high resolution image 312 and a thumbnail image 314, as described herein. The digital image data is communicated to the memory 302, via connection 320. Accordingly, the memory element 302 is configured to store many image files 310 having a high resolution image 312 and a thumbnail image 314. Alternatively, corresponding thumbnail images and high resolution images may be saved separately in memory element 302.

In another embodiment, an image file is transferred to the memory module unit 252 (FIG. 2A). When capturing images with digital camera 102, memory module unit 252 is coupled to digital camera 102 through memory unit interface 210. As the user of digital camera 102 actuates image capture actuation button 114 to cause camera processor 306 to capture the current image detected by photosensor 304, camera processor 306 communicates the image file to memory module unit 252.

Accordingly, memory module unit 252 is configured to store many image files having a header, high resolution image and a thumbnail image.

For convenience, digital camera 102 is described above as employing both a memory element 308 and a memory module unit 252 to store image files. Preferably, digital camera 102 would, in practice, employ either memory element 308 or memory module unit 252 to store image files because employing two different and separate memory systems would be inefficient and costly. (However, it is possible some embodiments of a digital camera 102 could employ both memory element 308 and memory module unit 252.)

A first encryption system and method resides in an embodiment of the thumbnail encryption logic 308 (FIG. 3B) implemented in digital camera 102. For convenience, the first encryption system and method is described below as implemented in thumbnail encryption logic 308. The first encryption system and method is similarly implemented in an embodiment of the PC thumbnail encryption logic 234 (FIG. 2B). Furthermore, as described herein, the encryption logic and/or the decryption logic may be implemented in other devices, such as, but not limited to, digital video cameras, FAX machines, copy machines or the like that are configured to generate image files having at least a high resolution image and a thumbnail image as described herein. Accordingly, for convenience and brevity, such other variants of the first encryption system and method (or first decryption system and method) as implemented in other devices are not described herein in detail.

The first encryption system and method selects pixel pairs that are to be encrypted with encryption information based upon selected portions of the image file. Thus, a predefined number of pixel pairs are used to store the encrypted information. Preferably, a large number of pixel pairs are defined such that anticipated large amounts of information can be encrypted into the encryption pixels. Thus, if the encrypted information does not require all of the predefined pixels, the unused encryption pixels are simply not encrypted with information.

The predefined locations are known to the thumbnail encryption logic 308 and are not easily identified, or preferably not identifiable, by an individual or code-breaking program. One pixel of each of the pixel pairs, the encryption pixel, is encoded by the thumbnail encryption logic 308 with information. Accordingly, a pixel location table 258 is employed for both encryption and decryption, where the pixel location table 258 specifies the location of at least one of the pixels of each predefined pixel pair. FIGS. 2B and 3B are block diagrams illustrating a pixel location table 258 residing in memory 216 of digital camera 102 and in memory element 302 of personal computer 202, respectively.

Another embodiment only identifies pixel locations of pixels residing in thumbnail image 108 or in high resolution image 106. Thus, since spatial relationships of the pixels of thumbnail image 108 and high resolution image 106 are known, the locations of both pixels of the pixel pair are easily determined.

Furthermore, one embodiment is configured to recognize that when a predefined number of encryption pixels that are unaltered (encryption pixel data matches the reference pixel data), the end of the information is recognized such that the decryption process may stop. For example, but not limited to, ten successive unaltered encryption pixels are predefined to signal the end of the encrypted information. Thus, if the information occasionally contains null data (such that an encryption pixel is unaltered), the decryption program will not misinterpret the null data as an end of the information.

For example, but not limited to, the file name may be the information that is to be encrypted into the encryption pixels. An exemplary file name might be “1234” in this simplified illustrative example. Furthermore, consider a grouping of predefined pixels pairs 49,50 and 980,1000; 51,46 and 1020,920; 97,89 and 1940,1960; and 99,122 and 1980,2440 (with other pixel pairs also defined in the predefined group of pixel pairs).

Once the pixel pairs are specified from pixel location table 258, encryption information can be embedded (encrypted) into the pixel data in any suitable manner. Since the location of the pixel pairs is coded directly into the thumbnail encryption logic 308 in one embodiment, and known from the pixel location table 258 in another embodiment, the predefined pixel pairs are secret. Furthermore, in this exemplary simplified scenario where the file name “1234” is encrypted into the encryption pixels, and since file name is likely to change with each image file, the encrypted file name uniquely identifies an image file because the file name is unique to each image file. Thus, a level of image security may be provided.

Continuing with the simplified encryption example where the file name “1234” is encrypted into pixel pairs 49,50 and 980,1000; 51,46 and 1020,920; 97,89 and 1940,1960; and 99,122 and 1980,2440, the information having four elements can be easily embedded into the selected encryption pixels (which may be either the thumbnail image pixel or the high resolution image pixel). Furthermore, let the selected encryption pixels be from the high resolution image (HRIP) pixels and have the values as shown in Table 1 below. Also, assume the green pixel value is altered when the encryption information is embedded into the encryption pixel. Thus, the thumbnail image pixel (TIP) values are not altered.

TABLE 1
Simpified Encryption Scheme

| | | Before | | After | | |
|---|---|---|---|---|---|---|
| | | Encryption | | Encryption | | Difference |
| Location | | TIP | HRIP | TIP | HRIP | in |
| TIP | HRIP | Value | Value | Value | Value | Value |
| 49, 50 | 980, 1000 | 100 | 100 | 100 | 110 | 1 |
| 51, 46 | 1020, 920 | 102 | 102 | 102 | 122 | 2 |
| 97, 98 | 1940, 1960 | 140 | 140 | 140 | 170 | 3 |
| 99, 122 | 1980, 2440 | 821 | 821 | 821 | 861 | 4 |

Table 1 illustrates that in the simplified example, the file name “1234” is encrypted into the green value (of the red, green, blue pixel values) of the encryption pixel, where the encryption pixel was selected from the high resolution image 106.

One embodiment correlates the information encrypted into the encryption pixels with a predefined character code set. Such a predefined character code set may be based upon an industry standard, such as, but not limited to, the ASCII character codes. Alternatively, the predefined character set could be specially designed and incorporated as part of the code of the thumbnail encryption logic 308.

For example, the character “)” may be included within a portion of the information. The character “)” has the ASCII character code of 41. The character code of 41 for the character “)” is discussed as a decimal number for convenience to facilitate the present disclosure. The character codes are preferably represented as binary numbers rather than decimal numbers. For example, the decimal number 41 can be represented as the eight bit binary number 00101001. In one embodiment, eight pixels are selected to store the binary number 00101001. In another embodiment, the red, green and blue color bits may be used to store information. For example, but not limited to, if a pixel employs eight bits, the decimal number 41 can be stored into one encryption pixel. If encryption pixels employ more bits (or less bits), then multiple numbers, and/or parts thereof, may be encrypted into the encryption pixels. The manners in which bits of an encryption pixel are encrypted with information is nearly limitless because the information is always determinable when an encryption pixel is compared with a reference pixel.

The simplified example above defined pixel locations in the thumbnail image based upon a simplified Cartesian coordinate system, where a pixel location is defined by a y-axis location and an x-axis location. Other embodiments use any suitable location definition systems, such as, but not limited to, a polar coordinate system.

When an image file is communicated to personal computer 202 (FIG. 2), as described above, an embodiment stores the image file in the PC image file region 230 of memory 216. Thumbnail decryption logic 232 is executed to retrieve the encrypted information. Since the thumbnail decryption logic 232 knows the predefined pixel pairs used to store the encrypted information, the encrypted encryption pixels are retrieved and compared with the reference pixel of the pixel pair. For example, and in reference to Table 1 above, the encrypted pixel from the high resolution image 106 in the 980,1000 location is retrieved (having a value of 110). Also, the corresponding reference pixel from the thumbnail image 108 in the 49,50 location is retrieved (having a value of 100). The green data is compared, indicating a difference of 1.

Thus, part of the information (having a value of 1) is determined. Similarly, the other three pixel pairs are evaluated, such that the encrypted information, the file name, of “1234” is determined.

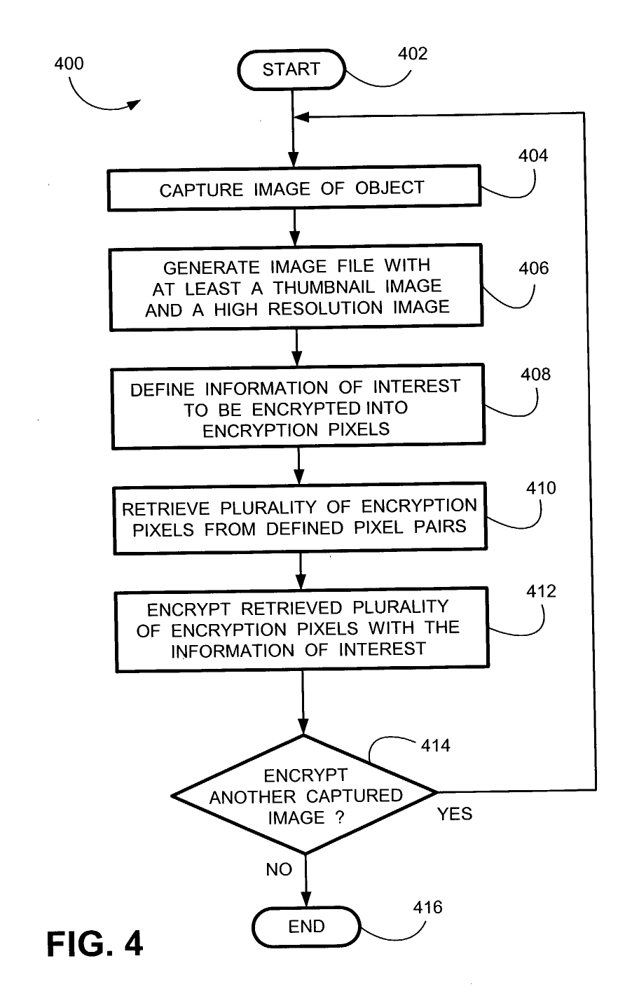

FIG. 4 is a flowchart 400 of a process for encrypting information into a plurality of predefined pixel pairs residing in a high resolution image 106 and in a thumbnail image 108 with an embodiment of the image capture device 102 of FIGS. 1-3. Flowchart 400 shows the architecture, functionality, and operation of one implementation of thumbnail information encryption system 100 configured to encrypt information into a plurality of predefined pixel pairs residing in a high resolution image 106 and in a thumbnail image 108. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved, as will be further clarified hereinbelow.

The process starts at block 402. At block 404, the image capture device 102 captures an image of the object of interest. At block 406, light information corresponding to the captured image of the object is received such that an image file is generated having at least a thumbnail image and a high resolution image. At block 408, information that is to be encrypted is defined. At block 410, the encryption pixels from the defined plurality of pixel pairs are retrieved. At block 412, the retrieved encryption pixels are encrypted with the information.

At block 414, a determination is made whether to encrypt another captured image with information. If so (the YES condition), the process returns to block 404.

If not (the NO condition), the process ends at block 416.

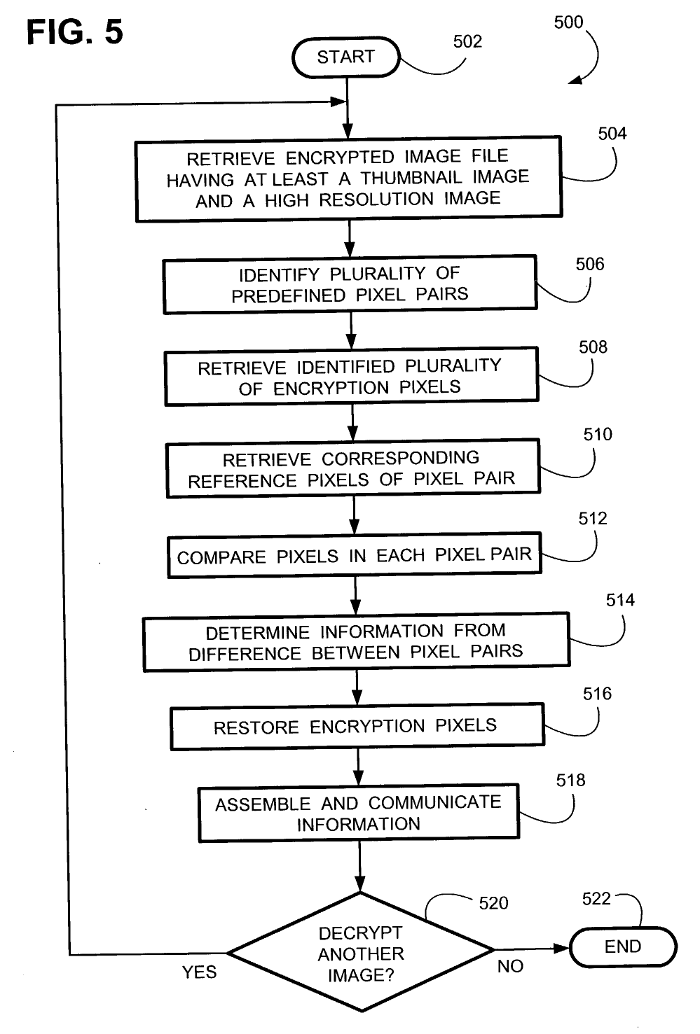

FIG. 5 is a flowchart 500 of a process for retrieving information from a plurality of pixel pairs residing in a high resolution image 106 and in a thumbnail image with an embodiment of personal computer 202 of FIG. 2. Flowchart 500 shows the architecture, functionality, and operation of one implementation of thumbnail decryption logic 232 configured to retrieve (decrypt) information from a plurality of pixel pairs residing in a high resolution image 106 and in a thumbnail image 108. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved, as will be further clarified hereinbelow.

The process starts at block 502. At block 504, an encrypted image file having at least a thumbnail image and a high resolution image is retrieved from a memory. At block 506, a plurality of predefined pixel pairs having the encrypted information is identified.

At block 508, the identified plurality of encrypted encryption pixels are retrieved. At block 510, the corresponding reference pixels of each pixel pair are retrieved. At block 512, for each pixel pair, a comparison is made to determine the difference in the data between the encryption pixel and the reference pixel. At block 514, the information is determined based upon the difference between the data of the pixels in the retrieved pixel pairs.

Preferably, in one embodiment, at block 516, the encryption pixels are restored and/or reconfigured to their pre-encryption value. The pre-encryption value of an encryption pixel is determined as described above using the reference pixel data. An alternative embodiment may omit block 516 if the encrypted pixels have been altered such that the altered pixel, when displayed, is not visibly discernible to a viewer of the image, or if it is desirable to have the pixel distortion viewed by a viewer of the encrypted image.

At block 518 the information retrieved from the encrypted pixels is assembled and communicated. In one embodiment, the information is communicated into a memory for later retrieval by the user. In another embodiment, the information is communicated to the user in a suitable format, such as in a visual form for printing on printing device 206, and/or for display on display 204 (FIG. 1)

At block 520, a determination is made whether information encrypted into another image is to be retrieved. If not (the NO condition), the process ends at block 522. If at block 520 if information is to be retrieved from another image (the YES condition), the process returns to block 504.

A second encryption system and method resides in another embodiment of the thumbnail encryption logic 308 (FIG. 3A) implemented in digital camera 102. For convenience, the second encryption system and method is described below as implemented in the thumbnail encryption logic 308. The second encryption system and method is similarly implemented in an embodiment of the PC thumbnail encryption logic 234 (FIG. 2A). Furthermore, as described herein, the encryption logic and/or the decryption logic may be implemented in other devices, such as, but not limited to, digital video cameras, FAX machines, copy machines or the like that are configured to generate image files having at least a high resolution image and a thumbnail image as described herein. Accordingly, for convenience and brevity, such other variants of the second encryption system and method (or second decryption system and method) as implemented in other devices are not described herein in detail.

The second encryption system and method encrypts the information into pixels as they are read from an image pixel. In the above-described simplified example where the information “1234” is encrypted into the encryption pixels, the “1” is encrypted into the first encryption pixel. The “2” is encrypted into the second encryption pixel. The “3” is encrypted into the third encryption pixel and the “4” is encrypted into the fourth encryption pixel. Thus, all pixels pairs in an image file may be used to encrypt information. Accordingly, very large information files may be encrypted into the image.

The second encryption system and method is configured to recognize that when a predefined number of encryption pixels that are unaltered (encryption pixel data matches the reference pixel data), the end of the information is recognized such that the decryption process may stop. For example, but not limited to, ten successive unaltered encryption pixels are predefined to signal the end of the encrypted information. Thus, if the information occasionally contains null data (such that an encryption pixel is unaltered), the decryption program will not misinterpret the null data as an end of the information.

Another embodiment encodes and end of file marker or code into the image at the end of the information file. Thus, upon completion of the process of encrypting the information into the image file, the next encryption pixel (or pixels if the end of file marker or code requires a plurality of encryption pixels) is encrypted with the end of file marker or code.

Another embodiment predefines the pixel pair (or a pixel in either the high resolution image or the thumbnail image) that will locate the first encryption pixel in which the information will be stored. Thus, the encryption pixels following the predefined encryption pixel, will be sequentially encoded with the information. This predefined first encryption pixel will also be known to the decryption program. Furthermore, if the pixel data is altered such that the altered pixel data is not discernable to a viewer, and if the first encryption pixel location is kept secret, the information may be secretly encoded into the image.

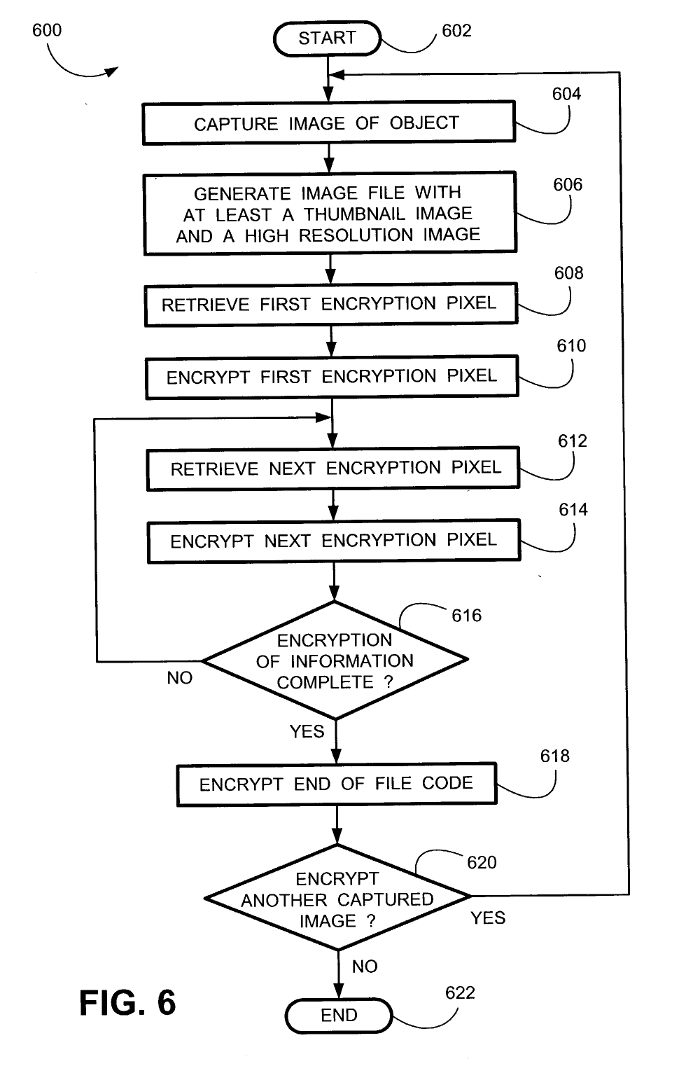

FIG. 6 is a flowchart 600 of a process for encrypting a plurality of sequential pixel pairs residing in a high resolution image 106 and in a thumbnail image 108 with information with an embodiment of the image capture device 102 of FIGS. 1-3. Flowchart 600 shows the architecture, functionality, and operation of one implementation of thumbnail information encryption system 100 configured to encrypt a plurality of sequential pixel pairs residing in a high resolution image 106 and in a thumbnail image 108 with information. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved, as will be further clarified hereinbelow.

The process starts at block 602. At block 604, the image capture device 102 captures an image of the object of interest. At block 606, light information corresponding to the captured image of the object is received such that an image file is generated having at least a thumbnail image and a high resolution image. At block 608, a first encryption pixel is retrieved. As described above, the location of at least one of the first encryption pixels is the first pixel, or in another embodiment, is specified.

At block 610, the first encryption pixel is encrypted with a portion of the information. At block 612, the next encryption pixel is retrieved. At block 614, the next encryption pixel is encrypted with the next portion of the information.

At block 616, a determination is made whether the information has been completely encrypted into the image. If not (the NO condition), the process returns to block 612. The process of blocks 612 through 616 repeats until the information is completely encrypted into the image. If the information has been completely encrypted into the image (the YES condition), the process proceeds to block 618.

At block 618, preferably, an end of file code (or marker) is encrypted into a subsequent encryption pixel. Alternatively, no end of file code (or marker) is encrypted such that during decryption, a series of unaltered encryption pixels will signal the end of the information. The process proceeds to block 620.

At block 620, a determination is made whether to encrypt another captured image. If so (the YES condition), the process returns to block 604. If not (the NO condition), the process ends at block 622.

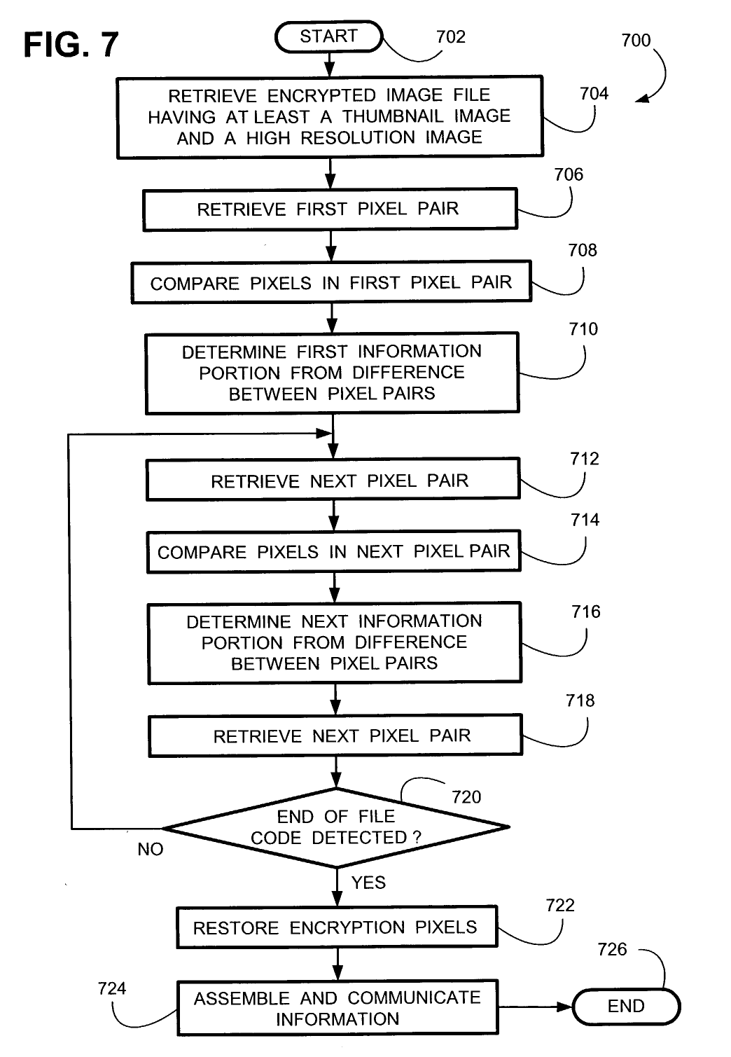

FIG. 7 is a flowchart 700 of a process for defining a plurality of pixel pairs residing in a high resolution image 106 and in a thumbnail image 108 based upon a predefined portion of an image file header with an embodiment of personal computer 202 of FIG. 2A. Flowchart 700 shows the architecture, functionality, and operation of one implementation of thumbnail decryption logic 232 configured to define a plurality of pixel pairs residing in a high resolution image 106 and in a thumbnail image 108 based upon a predefined portion of an image file header, and the decryption of information from selected encryption pixels. In this regard, each block represents a module, segment, or portion of code, which comprises one or more executable instructions for implementing the specified logical function(s). It should also be noted that in some alternative implementations, the functions noted in the blocks may occur out of the order noted in FIG. 7. For example, two blocks shown in succession in FIG. 7 may in fact be executed substantially concurrently or the blocks may sometimes be executed in the reverse order, depending upon the functionality involved, as will be further clarified hereinbelow.

The process starts at block 702. At block 704, an encrypted image file having at least a thumbnail image and a high resolution image is retrieved from a memory. At block 706, the first pixel pair is retrieved. Depending upon the embodiment that encrypted the information into the image, the first pixel retrieved from the encrypted image will have the first information portion. In another embodiment, the thumbnail decryption logic 232 will know which pixel is the predefined first encryption pixel.

At block 708, the pixels of the first pixel pair are compared. The difference in the data for the first pixel pair determines the first information portion, as indicated at block 710.

At block 712, the next pixel pair is retrieved. At block 714, the pixels of the next pixel pair are compared. The difference in the data for the next pixel pair determines the next information portion, as indicated at block 716.

At block 718, the next pixel pair is retrieved. Here, the next pixel pair is the pixel pair following the pixel pair retrieved at block 712. At block 718, a determination is made whether the information has been completely decrypted from the encrypted image, as indicated by the detection of an end of file code (or marker). In another embodiment, a predefined number of unaltered encryption pixels are detected to determine that the all of the information has been decrypted from the image. If not (the NO condition), the process returns to block 714. The process of blocks 714 through 720 repeats until the information is completely decrypted from the image.

Preferably, in one embodiment, at block 722, the encryption pixels are restored and/or reconfigured to their pre-encryption value. The pre-encryption value of the encryption pixels is determined as described above using the reference pixel data. An alternative embodiment may omit block 722 if the encrypted pixels have been altered such that the altered pixel, when displayed, is not visibly discernible to a viewer of the image, or if it is desirable to have the pixel distortion viewed by a viewer of the encrypted image.

At block 724 the information retrieved from the encrypted pixels is assembled and communicated. In one embodiment, the information is communicated into a memory for later retrieval by the user. In another embodiment, the information is communicated to the user in a suitable format, such as in a visual form for printing on printing device 206, and/or for display on display 204 (FIG. 1). The process ends at block 726.

In an alternative embodiment, a determination is made whether information encrypted into another image is to be retrieved. If not, the process ends at block 726. If information is to be retrieved from another image, the process returns to block 704.

When an image is captured by digital camera 102, or another suitably configured image capture device, pixels residing in photosensor 304 (or a photosensor if implemented in another image capture device) communicate light information to camera processor 306 (or a processor device if implemented in another image capture device). In one embodiment, the above-described encryption of the encryption pixels is implemented concurrently with the generation of the high resolution image 106 and the thumbnail image 108.

In another embodiment, encryption of the encryption pixels occurs after an image file has been generated. Thus, light information from the photosensor 304 is received and an image file having at least a header, a high resolution image and a thumbnail image is generated. After the image file is generated, an embodiment performs the above-described encryption of the encryption pixels.

In one embodiment, a suitable controller, such as, but not limited to, control button 110, is actuated to cause digital camera 102 to operate in a thumbnail information encryption mode. Accordingly, a subsequently captured image is then encrypted. Digital camera 102 remains in the thumbnail information encryption mode until control button 110 is actuated a second time, or until digital camera 102 is deactivated (shut off).

Alternatively, digital camera 102 may be configured to capture only the next image in the thumbnail information encryption mode, with an automatic return to a non-encryption mode of operation after the next image is captured. Thus, each image that is to be encrypted is identified by actuation of control button 110.

The above-described controller may be any suitable actuating device configured to at least allow a user to cause encryption of an image file. Examples of control button 110 include, but are not limited to, a push-button, a toggle-switch, a multi-position sensing device configured to sense a plurality of switch positions, a touch sensitive device or a light sensitive device. In one embodiment, the control button 110 is a multifunction controller configured to at least cause the digital camera 102 to operate in a thumbnail encryption mode of operation. Furthermore, the controller may be implemented as a menu screen displayed on display 120 and configured to cause digital camera 102 to operate in a thumbnail encryption mode of operation.

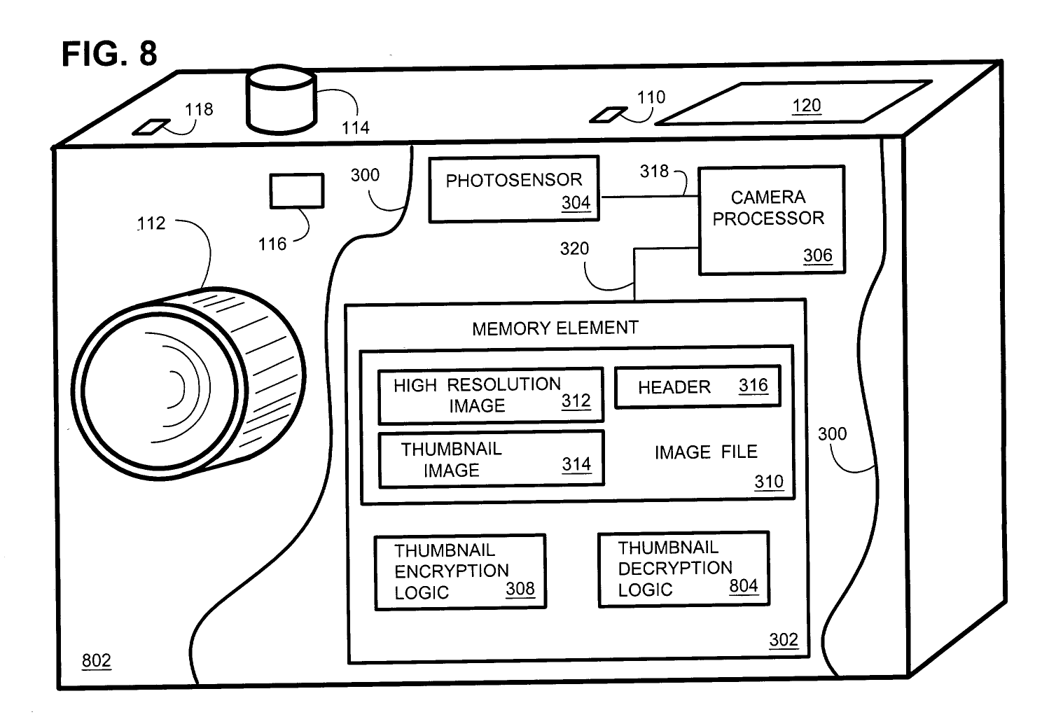

Various embodiments of the thumbnail decryption logic 232 (FIG. 2A) residing in personal computer 202 were described above. FIG. 8 is a block diagram of selected components of an embodiment of a digital camera 802 having camera decryption logic 804. The camera decryption logic 804 is configured to decrypt image files that have been encrypted in accordance with the above-described embodiments of the thumbnail information encryption system 100. Thus, a user of digital camera 802 may retrieve, from a remote memory, an encrypted image file. Accordingly, the retrieved information is then displayed on display 120.

Any of the above-described encryption processes may also be implemented in a similar manner in personal computer 202 or in another suitably configured image capture device. For example, but not limited to, PC thumbnail encryption logic 234 may reside in memory 216 (FIG. 2A). Accordingly, image files having at least a thumbnail image and a high resolution image are retrieved from the PC image file region 230. The retrieved image file is encrypted with information of interest. Such encryption process are exemplified in the flow charts 400 and 600 of FIGS. 4 and 6, respectively.

Furthermore, an image file from another device or memory can be retrieved and encrypted. A conventional digital camera may employ a memory module unit 252 where the image file is retrieved from. Or, the conventional digital camera could be coupled to personal computer 202 and the image file retrieved from a memory residing in the digital camera. Or, the image file could be retrieved from a remote memory via the Internet. Or, the image file could be retrieved from another suitable computer-readable memory medium. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic, compact flash card, secure digital, or the like), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

The information encrypted into a plurality of encryption pixels may be retrieved from any suitable source. For example, predefined information may be retrieved from a memory. Or, information may be retrieved from a device within the image capture device, such as a controller that determines exposure settings, a clock that determines time, or the like. Or, information may be provided from a character selection system. Examples of a character selection system include, but are not limited to, a menu configured to specify letters, a keyboard device, or a suitably configured controller such as control button and/or switch. Or, the information may be a previously captured image, watermark, logo or the like residing in a memory. Accordingly, embodiments are not limited as to the source of the information that is encrypted into the encryption pixels.

Furthermore, if the information is not originally provided in a form that is suitable for direct encryption into the encryption pixels, a conversion system or method may be included in an embodiment of the PC thumbnail encryption logic 234 and/or the thumbnail encryption logic 308. For example, but not limited to, information corresponding to a character string is converted into a suitable binary number string by one embodiment such that the binary numbers corresponding to the character string are encrypted into the encryption pixels. Furthermore, a corresponding conversion program associated with the thumbnail decryption logic 232 is configured to convert the information retrieved from the encryption pixels back into the format of the originally encrypted information. Accordingly, embodiments are not limited as to the type(s) and/or nature of the conversion program(s) used to convert received information into data suitable for encrypting into the encryption pixels and/or used to convert retrieved information from the encryption pixels.

What is claimed is:

1. A method for encrypting information into an image file with an image capture device, the method comprising the steps of:
receiving information corresponding to a captured image from a photosensor;
generating a first image from the received information, the first image comprised of at least a plurality of first pixels corresponding to the captured image;
generating a second image from the received information, the second image having a different resolution than the first image and comprised of at least a plurality of second pixels corresponding to the captured image;
selecting a plurality of encryption pixels from the plurality of first pixels, such that each one of the plurality of selected encryption pixels corresponds uniquely to one of the plurality of second pixels of the second image; and
altering data of the selected plurality of encryption pixels such that information of interest is encrypted into the selected plurality of encryption pixels, and such that corresponding ones of the plurality of second pixels remains unaltered so that the information of interest is determinable by comparing the encryption pixels with the unaltered second pixels.

2. The method of claim 1, further comprising the step of receiving the information of interest.

3. The method of claim 1, further comprising the step of combining at least the first image and the second image into the image file.

4. The method of claim 1, wherein the first image is a lower resolution image relative to the second image.

5. The method of claim 4, wherein the first image is a thumbnail image.

6. The method of claim 1, wherein the first image is a higher resolution image relative to the second image.

7. The method of claim 6, wherein the second image is a thumbnail image.

8. The method of claim 1, further comprising the step of actuating a controller configured to cause the image capture device to operate in a thumbnail information encryption mode such that when an image is captured, the image file is generated having at least the first image with the plurality of encryption pixels that are encrypted with the information of interest and the second image.

9. The method of claim 8, wherein the image capture device comprises at least one selected from the group consisting of a digital camera, a facsimile (FAX) machine and a copy machine.

10. The method of claim 1, wherein the step of selecting the plurality of encryption pixels from the plurality of first pixels further comprises the step of selecting the encryption pixels according to a predefined location table, the predefined location table specifying at least an order in which the encryption pixels are retrieved and at least location information that determines a location for each one of the encryption pixels.

11. The method of claim 1, wherein the step of selecting the plurality of encryption pixels from the plurality of first pixels further comprises the step of selecting a first encryption pixel such that a first portion of the information of interest is encrypted into the first encryption pixel, and such that a plurality of subsequent portions of information are each encrypted into a plurality of next encryption pixels in the order that the next encryption pixels are received.

12. A method for encrypting information into an image file, the method comprising the steps of:
receiving at least a first image and a second image, the first image comprised of a plurality of first pixels corresponding to a captured image, and the second image comprised of a plurality of second pixels corresponding to the captured image;
selecting a plurality of encryption pixels from the plurality of first pixels, such that each one of the plurality of selected encryption pixels corresponds uniquely to one of the plurality of second pixels of the second image; and
altering data of each one of the selected plurality of encryption pixels such that information of interest is encrypted into the selected plurality of encryption pixels, and such that the corresponding ones of the plurality of second pixels remains unaltered so that the information of interest is determinable by comparing the encrypted pixels with the unaltered second pixels.

13. The method of claim 12, further comprising the step of receiving the information of interest.

14. The method of claim 12, wherein the step of receiving further comprises the step of receiving an image file, the image file having at least the first image and the second image.

15. The method of claim 12, wherein the first image is a lower resolution image relative to the second image.

16. The method of claim 15, wherein the first image is a thumbnail image.

17. The method of claim 12, wherein the first image is a higher resolution image relative to the second image.

18. The method of claim 17, wherein the second image is a thumbnail image.

19. The method of claim 12, wherein the step of selecting the plurality of encryption pixels from the plurality of first pixels further comprises the step of selecting the encryption pixels according to a predefined location table, the predefined location table specifying at least an order in which the encryption pixels are retrieved and at least location information that determines a location for each one of the encryption pixels.

20. The method of claim 12, wherein the step of selecting the plurality of encryption pixels from the plurality of first pixels further comprises the step of selecting a first encryption pixel such that a first portion of the information of interest is encrypted into the first encryption pixel, and such that a plurality of subsequent portions of information are each encrypted into a plurality of next encryption pixels in the order that the next encryption pixels are received.

21. A method for determining information encrypted into an image file, the method comprising the steps of:
accessing at least a first image corresponding to a captured image comprised of at least a plurality of encryption pixels, and a second image corresponding to the captured image comprised of at least a plurality of second pixels, the second image having a different resolution than the first image, and each one of the plurality of second pixels uniquely corresponding to one of the plurality of encryption pixels;
retrieving the plurality of encryption pixels;
retrieving the plurality of corresponding second pixels;
determining a difference between each one of the retrieved encryption pixels and the corresponding second pixel; and
determining information corresponding to the determined difference.

22. The method of claim 21, wherein the step of receiving further comprises the step of receiving an image file, the image file having at least the first image and the second image.

23. The method of claim 21, wherein the first image is a lower resolution image relative to the second image.

24. The method of claim 23, wherein the first image is a thumbnail image.

25. The method of claim 21, wherein the first image is a higher resolution image relative to the second image.

26. The method of claim 25, wherein the second image is a thumbnail image.

27. The method of claim 21, further comprising the step of altering data of the encryption pixel to correspond to data of the corresponding second pixel so that when the first image is displayed the displayed first image appears undistorted.

28. The method of claim 21, wherein the step of retrieving the plurality of encryption pixels further comprises the step of selecting the encryption pixels according to a predefined location table, the location table specifying at least an order in which the encryption pixels are retrieved and at least location information that determines a location for each one of the encryption pixels.

29. The method of claim 21, wherein the step of retrieving the plurality of encryption pixels further comprises the step of selecting a first encryption pixel such that a first portion of information of interest is encrypted into the first encryption pixel, and such that a plurality of subsequent portions of information are each encrypted into a plurality of next encryption pixels in the order that the next encryption pixels are received.

30. An image capture device which identifies captured images, comprising:
a photosensor configured to capture an image; and
a processor configured to:
receive information corresponding to the captured image;
generate a first image corresponding to the captured image and having at least a plurality of encryption pixels;
generate a second image corresponding to the captured image and having at least a plurality of second pixels, each one of the second pixels uniquely corresponding to one of the encryption pixels;
receive information of interest;
alter data of each one of the plurality of encryption pixels such that the information of interest is encrypted into the selected plurality of encryption pixels, and such that corresponding ones of the plurality of second pixels remains unaltered so that the information of interest is determinable by comparing the encrypted pixels with the unaltered second pixels; and
generate an image file comprised of at least the first image and the second image.

31. The device of claim 30, further comprising a memory configured to store the image file comprised of the first image and the second image.

32. The device of claim 30, further comprising a controller configured to cause the image capture device to operate in a thumbnail information encryption mode when the controller is actuated.

33. The device of claim 32, further comprising a display and wherein the controller is implemented on a menu displayed on the display.

34. The device of claim 30, wherein the device comprises at least one selected from the group consisting of a digital camera, a facsimile (FAX) machine and a copy machine.

35. A computer readable medium having a program for encrypting captured images, the program comprising logic configured to perform the steps of:
accessing at least a first image and a second image, the second image having at least a plurality of reference pixels and having a different resolution than the first image;
generating a third image corresponding to the first image and having at least a plurality of encryption pixels, and such that each one of the encryption pixels corresponds uniquely to one of the reference pixels in the second image;
altering data of each one of the plurality of encryption pixels such that the information of interest is encrypted into the selected plurality of encryption pixels, and such that the corresponding ones of the plurality of reference pixels remains unaltered so that the information of interest is determinable by comparing the encrypted pixels with the unaltered reference pixels; and
generating an encrypted image file comprised of at least the second image and the third image.

36. An image capture device which identifies captured images, comprising:
means for receiving at least a first image and a second image, the first image comprised of a plurality of first pixels corresponding to a captured image, and the second image comprised of a plurality of second pixels corresponding to the captured image;
means for selecting a plurality of encryption pixels from the plurality of first pixels, such that each one of the plurality of selected encryption pixels corresponds uniquely to one of the plurality of second pixels of the second image; and
altering data of each one of the selected plurality of encryption pixels such that information of interest is encrypted into the selected plurality of encryption pixels, and such that the corresponding ones of the plurality of second pixels remains unaltered so that the information of interest is determinable by comparing the encrypted pixels with the unaltered second pixels

37. The system of claim 36, further comprising means for receiving an image file, the image file having at least the first image and the second image.

38. The system of claim 36, further comprising means for receiving the information of interest.
